(19) United States
(12) Patent Application Publication
(10) Pub. No.: US 2019/0023911 A1
(43) Pub. Date: Jan. 24, 2019

(54) POWDER COATINGS AND COMPOSITIONS THEREOF AND METHODS FOR COATING AN ARTICLE

(71) Applicant: AXALTA COATING SYSTEMS IP CO., LLC, Wilmington, DE (US)

(72) Inventor: Tatiana Eliseeva, Houston, TX (US)

(73) Assignee: AXALTA COATING SYSTEMS IP CO., LLC, Wilmington, DE (US)

(21) Appl. No.: 16/033,805

(22) Filed: Jul. 12, 2018

Related U.S. Application Data
(60) Provisional application No. 62/536,089, filed on Jul. 24, 2017.

(51) Int. Cl. C09D 5/18; C09D 5/03; C09D 163/00; C09D 163/10; B05D 3/02; B05D 1/24

(52) U.S. Cl. CPC C09D 5/18; C09D 5/03; C09D 5/035; B05D 1/24; C09D 163/00; C09D 163/10; B05D 3/0254; C09D 5/037

(57) ABSTRACT

Powder coatings and compositions thereof, and methods for coating an article are provided. In one example, a composition for a powder coating includes a binder including a binder resin portion and a binder curing portion. The binder resin portion includes a first epoxy resin having an epoxide equivalent weight of from about 400 to about 450 g/eq. A second epoxy resin has an epoxide equivalent weight of from about 1600 to about 1950 g/eq. A third epoxy resin has an epoxide equivalent weight of from about 850 to about 1050 g/eq.

### CROSS-REFERENCE TO RELATED APPLICATIONS

This application is related to and claims all available benefit of U.S. Provisional Patent Application 62/536,089 filed Jul. 24, 2017, the entire contents of which are herein incorporated by reference.

### TECHNICAL FIELD

The technical field relates generally to powder coatings, and more particularly to powder coatings and compositions thereof, and methods for coating an article.

### BACKGROUND

Powder coatings are used, for example, to form insulation on wires or the like. While these powder coatings may have desirable characteristics, there is a need for improved coatings with relatively high flexibility, good mechanical and physical properties, ability to withstand elevated temperatures, and/or good economics.

Accordingly, it is desirable to provide compositions for coatings, powder coatings, and methods for coating an article which address one or more of the foregoing desired improvements. Furthermore, other desirable features and characteristics of the present disclosure will become apparent from the subsequent detailed description and the appended claims, taken in conjunction with this background.

### BRIEF SUMMARY

Compositions for a powder coating, powder coatings, and methods for coating an article are provided herein. In accordance with an exemplary embodiment, a composition for a powder coating includes a binder with a binder resin portion and a binder curing portion. The binder resin portion includes a first epoxy resin having an epoxide equivalent weight of from about 400 to about 450 g/eq. A second epoxy resin has an epoxide equivalent weight of from about 1600 to about 1950 g/eq. A third epoxy resin has an epoxide equivalent weight of from about 850 to about 1050 g/eq.

In accordance with another exemplary embodiment, a powder coating is provided. The powder coating is made by dry mixing a composition. The composition includes a binder including a binder resin portion and a binder curing portion. The binder resin portion includes a first epoxy resin having an epoxide equivalent weight of from about 400 to about 450 g/eq. A second epoxy resin has an epoxide equivalent weight of from about 1600 to about 1950 g/eq. A third epoxy resin has an epoxide equivalent weight of from about 850 to about 1050 g/eq. The composition is extruded, cool to form a solid, and grinded into a powder.

In accordance with another exemplary embodiment, a method for coating an article is provided. The method includes applying a powder coating to the article to form a powder coated article. The powder coating is made by dry mixing a composition. The composition includes a binder including a binder resin portion and a binder curing portion. The binder resin portion includes a first epoxy resin having an epoxide equivalent weight of from about 400 to about 450 g/eq. A second epoxy resin has an epoxide equivalent weight of from about 1600 to about 1950 g/eq. A third epoxy resin has an epoxide equivalent weight of from about 850 to about 1050 g/eq. The composition is extruded, cool to form a solid, and grinded into a powder. The powder coated article is exposed to heat.

### DETAILED DESCRIPTION

The following Detailed Description is merely exemplary in nature and is not intended to limit the various embodiments or the application and uses thereof Furthermore, there is no intention to be bound by any theory presented in the preceding background or the following detailed description.

Various embodiments contemplated herein relate to compositions for powder coatings, powder coatings, and methods for coating an article. In an exemplary embodiment, a composition for a powder coating includes a binder that includes a binder resin portion and a binder curing portion. The binder resin portion includes a first epoxy resin, a second epoxy resin, and a third epoxy resin. The first epoxy resin has an epoxide equivalent weight of from about 400 to about 560 g/eq. The second epoxy resin has an epoxide equivalent weight of from about 1600 to about 1950 g/eq. The third epoxy resin has an epoxide equivalent weight of from about 850 to about 1050 g/eq.

In a first exemplary embodiment of the binder resin portion, the first epoxy resin (referred to herein as “first epoxy resin 1a” and as shown in Tables 1A and 1B) is a relatively low molecular weight and relatively high glass transition (Tg) modified epoxy resin having an epoxide equivalent weight of from about 400 to about 450 g/eq, an epoxide percent (%) of from about 9.6 to about 10.8, an epoxide group content of from about 2220 to about 2500 mmol/kg, a softening point of from about 105 to about 114° C., a melting point of about 150° C. and a viscosity at 150° C. of from about 7500 to about 9500 mPa·s. As used herein, the softening point and/or the melting point may be determined using various known techniques, such as for example, by characterization of the various epoxy resins described herein using differential scanning calorimetry (DSC) including determining the glass transition or softening temperature T(g), and the melting point using, for example, a heating rate of 20° C/min. The first epoxy resin 1a is commercially available, for example, under the trade name D.E.R.™ 6510HT Epoxy Resin, which is manufactured by Dow Chemical Company.

The second epoxy resin (referred to herein as “second epoxy resin 2” and as shown in Tables 1A and 1B) is a relatively flexible and relatively high molecular weight epoxy resin that is the product reaction of epichlorohydrin and bisphenol A and has an epoxide equivalent weight of from about 1600 to about 1950 g/eq, an epoxide % of from about 2.2 to about 2.7, an epoxide group content of from about 510 to about 625 mmol/kg, a softening point of from about 126 to about 137° C., and a viscosity as a solution at 25° C. of from about 2000 to about 2900 cSt. The second epoxy resin 2 is commercially available, for example, under the trade name D.E.R.™ 667E Epoxy Resin, which is manufactured by Dow Chemical Company.

The third epoxy resin (referred to herein as “third epoxy resin 3” and as shown in Tables 1A and 1B) is a carboxyl-terminated-butadiene-nitrile (CTBN) modified epoxy resin that is an adduct of a bisphenol A epoxy resin and carboxyl-terminated-butadiene-nitrile rubber and has an epoxide equivalent weight of from about 850 to about 1050 g/eq, a softening point of from about 65 to about 85° C., a melting point of about 150° C. and a viscosity at 150° C. of from about 50 to about 200 poise. The third epoxy resin 3 is commercially available, for example, under the trade name HyPox™ RK820 CTBN Elastomer Modified Epoxy Resin, which is manufactured by CVS Thermoset Specialties.

In one exemplary embodiment, the first epoxy resin 1a, the second epoxy resin 2, and the third epoxy resin 3 together form 100% of the binder resin portion. In one example, the binder resin portion includes from about 40 to about 50 wt. % such as about 45 wt. % of the first epoxy resin 1a, from about 45 to about 55 wt. % such as about 50 wt. % of the second epoxy resin 2, and from about 1 to about 10 wt. % such as about 5 wt. % of the third epoxy resin 3 based on the total weight of the binder resin portion. In another example, a ratio of the first epoxy resin 1a, the second epoxy resin 2, and the third epoxy resin 3 is from about 0.9:1:0.1 to about 1:1:0.3 such as about 1:1:0.2. In this embodiment and as will be discussed in further detail below, the binder resin portion in combination with the binder curing portion and optionally other additives may form part of a coating, for example a powder coating, that is particularly well-suited for insulation applications for wires, e.g., magnet wires, with an ability to withstand elevated temperatures, e.g., heat shock up to at least about 220° C., for example about 220° C., with relatively high flexibility and good mechanical and high electrical insulation properties.

In a second exemplary embodiment of the binder resin portion, the first epoxy resin (referred to herein as “first epoxy resin 1b” and as shown in Tables 1A and 1B) is a novolac modified medium molecular weight epoxy resin having an epoxide equivalent weight of from about 500 to about 560 g/eq, an epoxide percent (%) of from about 7.7 to about 8.6, an epoxide group content of from about 1790 to about 2000 mmol/kg, a softening point of from about 90 to about 98° C., and a viscosity as a solution at 25° C. of from about 370 to about 500 cSt. The first epoxy resin 1b is commercially available, for example, under the trade name D.E.R.™ 642U Epoxy Resin, which is manufactured by Dow Chemical Company, and/or under the trade name NPES™ 660U Epoxy Resin, which is manufactured by Nanya Epoxy.

The second and third epoxy resins, in this second exemplary embodiment, are the same as those disclosed in the foregoing paragraphs with respect to the first exemplary embodiment and are designated accordingly as the second epoxy resin 2 and the third epoxy resin 3, respectively. In one exemplary embodiment, the first epoxy resin 1b, the second epoxy resin 2, and the third epoxy resin 3 together form 100% of the composition of the binder resin portion. In one example, the binder resin portion includes from about 20 to about 30 wt. % such as about 25 wt. % of the first epoxy resin 1b, from about 65 to about 75 wt. % such as about 70 wt. % of the second epoxy resin 2, and from about 1 to about 9 wt. % such as about 5 wt. % of the third epoxy resin 3 based on the total weight of the binder resin portion. In another example, a ratio of the first epoxy resin 1b, the second epoxy resin 2, and the third epoxy resin 3 is from about 1:2:0.1 to about 1:3:0.3 such as from about 1:2:0.3 to about 1:2.5:0.2. In this embodiment and as will be discussed in further detail below, the binder resin portion in combination with the binder curing portion and optionally other additives may form part of a coating, for example a powder coating, that is particularly well-suited for insulation applications for wires, e.g., magnet wires, with an ability to withstand elevated temperatures, e.g., heat shock up to at least about 180° C., for example about 180° C., with relatively high flexibility, good mechanical properties and economics.

As discussed above, the binder includes the binder curing portion for curing the binder resin portion (e.g., the first embodiment binder resin portion including epoxy resins 1a, 2, and 3, or alternatively, the second embodiment binder resin portion including epoxy resins 1b, 2, and 3). The binder curing portion includes a curing agent. In an exemplary embodiment, the curing agent includes dicyandiamide. In particular, it has been found that dicyandiamide is a particularly effective curing agent for curing thin film coating compositions, such as on wires or the like, effectively reducing or eliminating pock marks and/or cratering in the cured thin-film.

Other curing agents may be used in either in combination with or without the presence of dicyandiamide. Some examples of other curing agents include pyromellitic diahydride, tetrahydrophthalic anhydride, benzophenone tetracarboxylic dianhydride, trimellitic acid, some standard anhydride curing agents, aromatic amines and/or aliphatic amines such as ethylene diamine, diethylene triamine, triethylene tetramine, dimethylamine propylamine, benzyldimethylamine, and methylene dianiline, or the like.

In addition to the curing agent, the binder curing portion may include an accelerator for decreasing the cure time of the composition. In an exemplary embodiment, the binder curing portion includes 2-methyl imidazole. Commercially available examples of an accelerator which is a mixture of 2-methyl imidazole and dicyandiamide include, under the trade names, Epikure™ P108/Epicure™ P104 which is manufactured by Hexion, Dyhard™ 100S/Dyhard™ MI which is manufactured by Evonic, and D.E.H.™ 40 which is manufactured by Dow Chemical Company. A complete description of accelerators that are mixtures of dicyandiamide and an imidazole, which can be used in various embodiments of the present disclosure, can be found in U.S. Pat. No. 3,631,150, which is herein incorporated by reference. Other accelerators that can be used include dihydrazide, nitrohydrazide, stannous octoate, epoxy novolac resins, and/or the like.

In an exemplary embodiment, the binder curing portion is present in the binder at a concentration such that there is a stoichiometric excess of epoxy relative to the binder curing portion. That is, the epoxy equivalent weight (e.g., effective active sites) of the epoxy resins in the binder resin portion is in excess or greater than the curing agent equivalent weight (e.g., effective active sites) of the binder curing portion. In one example, the binder has a stoichiometric excess of epoxy of about 10% relative to the curing agent portion (e.g. stoichiometric ratio of about 1.1 of epoxy to the curing agent). In an exemplary embodiment, the binder curing portion includes the curing agent and the accelerator at a ratio of about 2:1. In another exemplary embodiment, the binder curing portion is present in the binder in an amount of from about 3 to about 7 wt. % such as about 5 wt. % based on the total weight of the binder.

In addition to the binder, the composition may further include other additives. For example, the composition may include one or more flow control agents, pigments and/or dyes, performance enhancers, processing agents or additives, and/or the like. In an exemplary embodiment, the composition includes a flow control agent to aid in producing, for example, a more uniform coating having a smoother, glossier appearance. In one example, the flow control agent is an acrylic polymer (e.g., polyacrylate or the like). Examples of commercially available flow control agents include, under the trade names, Modaflow™ which is manufactured by Monsanto chemical company, Resiflow™ RF6000 which is manufactured by Estron, and Modarez™ MFP which is manufactured by Cytex. Other suitable flow control agents include thixotropes such as fumed silica (e.g., commercially available under the trade names Aersosil™ or Cab-O-Sil™ from Cabot), pulverized asbestos, bentonite clay, or the like may be used. In an exemplary embodiment, the composition includes a flow control agent present in an amount of from about 0.5 to about 1.5 wt. %, such as from about 0.2 to about 1 wt. %, based on the total weight of the composition.

In an exemplary embodiment, the composition includes a polyvinyl acetate (PVA) additive for improving flow and pigment wetting properties. A commercially available example of such an additive is available under the trade name Mowital™ which is manufactured by Kuraray. In an exemplary embodiment, the composition includes a PVA additive in an amount of from about 0 to about 5 wt. % based on the total weight of the composition.

In an exemplary embodiment, the composition includes one or more pigments, such as titanium dioxide pigments for providing opacity and/or colored pigments such as a yellow pigment(s) (e.g., iron oxide pigments, nickel pigments, antimony rutile pigments or the like) for providing color. Examples of commercially available pigments include, under the trade name, Hitox™ for titanium dioxide pigments, or for colored pigments include, under the trade names, YLO™-1888D, MAPICO™ Yellow 1050A, Bayferrox™ 930, Yellow™ 10C112, Tipaque Yellow™ TY-70. In an exemplary embodiment, the composition includes titanium dioxide pigments in an amount of from about 0 to about 5 wt. % based on the total weight of the composition, and/or colored pigments in an amount of from about 0 to about 5 wt. % based on the total weight of the composition.

In an exemplary embodiment, the composition includes a performance enhancer such as ceramic beads or the like as an enhancer for dielectric resistance. A commercially available example of such a performance enhancer is available under the trade name Zeeospheres Ceramic Microspheres™ G-200 which is manufactured by Zeeospheres Ceramics or 3M. In an exemplary embodiment, the composition includes a performance enhancer in an amount of from about 0 to about 5 wt. % based on the total weight of the composition.

In an exemplary embodiment, the composition is composed primarily of the binder with a minor concentration of additives, such as those additives discussed in the foregoing paragraphs. In an exemplary embodiment, the composition includes the binder present in an amount of from about 70 to about 100 wt. %, such as from about 80 to about 100 wt. %, for example from about 90 to 99 wt. % based on the total weight of the composition. In an exemplary embodiment, the additives make up a remaining portion of the composition that is less the binder.

In an exemplary embodiment, a powder coating is made using the composition as discussed above. In one embodiment, the composition is homogeneously dry mixed and is provided, for example, to an extruder. Advantageously, the extruder helps obtaining a highly flexible coating although two-roll mills and other types of mixers may be used. In an exemplary embodiment, a type of extruder called a kneader is used. A kneader functions in the same way as a conventional extruder, but also imparts a reciprocating axial motion to the extruder screw or screws. In an exemplary embodiment, the extrusion of the composition is performed just above the melting point of the composition, which is for example at about 40 to about 100° C. Several heat zones are common, for example, the extruder may have a back zone at about 40 to about 60° C. and a die at about 90 to about 100° C. In an exemplary embodiment, the residence time in the extruder is from about 2 to about 3 minutes, and if the extruder is a kneader, from about 60 to about 90 seconds.

After extrusion, the composition is cooled to form a solid, and is ground, for example, in a microcrusher to produce pieces about 0.25 to about 0.5 inches in size. The pieces are ground, for example, in a pulverizer and are then passed through a sieve to obtain the powder. Fine powders are used for making thin coatings, but if the powder is too fine, it will not fluidize well and may create issues. In an exemplary embodiment, the particle size is at least about 400 mesh (i.e., about 37 μm) and is finer than about 100 mesh (i.e., about 149 μm). It has been found that by having substantially all of the particles in the powder coating fall within the range of about 100 to about 400 mesh, the powder coating may be effectively used in an electrostatic fluidized bed. In one example, the particles in the powder coating are in the range of about 200 mesh (74 μm) and about 400 mesh (37 μm).

In an exemplary embodiment, a method for coating an article with the powder coating as discussed in the foregoing paragraphs is provided. The powder coating is applied to an article, such as a wire or the like, to form a powder coated article. In particular, the powder may be applied to the article using a fluidized bed, or other application apparatus. Electrostatic guns or electrostatic fluidized beds have been found to be effective for producing thin, uniform films, for example less than about 2 mils in thickness. The wire or article to be coated is grounded and the powder coating is charged by contacting with charged air, causing the powder coating to cling to the wire or article and form a dry powder layer on the surface of the article. Then the powder coated article is exposed to heat for melting and curing of the powder coating. In some cases, a quenching step is involved to bring the temperature of the coated article down rapidly. Then a protected layer or film is formed.

In an exemplary embodiment, curing of the powder coating is performed in an oven at from about 125 to about 250° C. for about 1 to about 25 minutes. The cure time depends on the temperature. Higher temperatures may be used for wire coatings than for coating large surfaces. The curing time can often be reduced, for example, by using additional infrared or induction heating, which may be especially useful in coating wires. In an exemplary embodiment, a wire coating of about 1 to 16 mils results, depending on the size of the charge and other variables.

The following Tables, specifically Tables 1A and 1B, provided below are an example(s) of various compositions for powder coatings in accordance with an exemplary embodiment. The examples are provided for illustration purposes only and are not meant to limit the various embodiments of the composition in any way.

### EXAMPLES

### Compositions for Powder Coatings

TABLE 1A

| Components | General name | examples of product | Chemical composition | Role in formulation |
|---|---|---|---|---|
| Resin 1a | Low molecular | DER6510HT; | Modified epoxy resin | provides excellent chemical and |
| | weight high Tg | Epon164 | | corrosion resistance and high |
| | resin | | | glass transition temperature (Tg) |
| Resin 2 | Very flexible | DER667E | product reaction of | provides flexibility |
| | high molecular | | epichlorohydrin and | |
| | weight resin | | bisphenol A; CASRN | |
| | | | 25036-25-3 | |
| Resin 3 | CTBN modified | HyPox RK820 | mixture of bisphenol A | provides improved impact and |
| | epoxy resin | | epoxy resin (65-75%) and | toughness |
| | | | bisphenol A epoxy resin | |
| | | | with carboxyl-termninated- | |
| | | | butadiene-nitrile rubber | |
| | | | adduct (25-35%) | |
| Resin 1b | novolac | DER642U NPES- | product reaction of | provides good mechnical |
| | modified | 660U EPON2012 | epichlorohydrin and | properties and chemical |
| | medium | | bisphenol A | resistance |
| | molecular | | | |
| | weight | | | |
| Curing | Dicy/Imidazole | EPIKURE | dicyandiamide/2-methyl | act as catalyst and curring |
| agent/catalyst | | P108/EPICURE P- | imidazole | agent for epoxy resins |
| | | 104; Dyhard 100S/ | | |
| | | Dyhard MI | | |
| Flow control | flow agent | resiflow RF-6000; | acrilic polymer. Proprietery | helps with processing and |
| agent | | modarez MFP; | | application requierments by |
| | | modaflow | | surface defects reduction |
| additive 1 | PVB | mowital | polyvinyl acetale | improves flow and pigment |
| | | | | wetting properties |
| additive 2 | fumed silica | aerosil, cab-o-sil | silica dioxide | Post add: provides fluidization |
| | | | | of powder |
| additive 3 | titanium | Hitox | titanium dioxide | pigment, provides opacity |
| | dioxide | | | |
| additive 4 | yellow pigment | YLO-1888D; | iron oxide | pigment, provides color |
| | | MAPICO Yellow | | |
| | | 1050A; Bayferrox 930 | | |
| additive 5 | yellow pigment | yellow 10C112; | NICKEL ANTIMONY | pigment, provides color |
| | | Tipaque yellow TY-70 | RUTILE | |
| additive 6 | ceramic beads | Zeeospheres ceramic | ceramic beads | Dielectric resistance enhancer |
| | | microspheres G-200 | | |

TABLE 1B

| | | | | Epoxide | | | |
|---|---|---|---|---|---|---|---|
| | | Epoxide | | group | soften | | |
| | | eqivalent | | content, | point, | | % in the |
| Components | General name | weight, g/eq | Epox. % | mmol/kg | ° C. | Viscosity | composition |
| Resin 1a | Low molecular | 400-450 | 9.6-10.8 | 2220-2500 | 105-114 | 7500-9500 melted at | 45-50-5 |
| | weight high Tg | | | | | 150° C., mPa · s | |
| | resin | | | | | | |
| Resin 2 | Very flexible | 1600-1950 | 2.2-2.7 | 510-625 | 126-137 | 2000-2900 solution at | 45-50-5 |
| | high molecular | | | | | 25° C., cSt | |
| | weight resin | | | | | | |
| Resin 3 | CTBN modified | 850-1050 | NA | NA | 65-85 | 50-200 melted at | 45-50-5 |
| | epoxy resin | | | | | 150° C., poise | |
| Resin 1b | novolac | 500-560 | 7.7-8.6 | 1790-2000 | 90-98 | 370-500 solution at | 25-70-5 |
| | modified | | | | | 25° C., cSt | |
| | medium | | | | | | |
| | molecular | | | | | | |
| | weight | | | | | | |

| | | | |
|---|---|---|---|
| Curing agent | Dicy/Imidazole | NA | stoicheometry |
| and/or | | | of the binder: |
| catalyst | | | 1.10 |
| Flow control | flow agent | NA | 0.5-1.5 |
| agent | | | |
| additive 1 | PVB | NA | 0-5 |
| additive 2 | fumed silica | NA | 0.2-1.0 |
| additive 3 | titanium | NA | 0-5 |
| | dioxide | | |
| additive 4 | yellow pigment | NA | 0-5 |
| additive 5 | yellow pigment | NA | 0-5 |
| additive 6 | ceramic beads | NA | 0-5 |

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A composition for a powder coating, the composition comprising:
a binder comprising a binder resin portion and a binder curing portion, wherein the binder resin portion comprises:
a first epoxy resin having an epoxide equivalent weight of from about 400 to about 450 g/eq;
a second epoxy resin having an epoxide equivalent weight of from about 1600 to about 1950 g/eq; and
a third epoxy resin having an epoxide equivalent weight of from about 850 to about 1050 g/eq.

2. The composition of claim 1, wherein the first epoxy resin has an epoxide group content of from about 2220 to about 2500 mmol/kg.

3. The composition of claim 1, wherein the first epoxide resin has a softening point T(g) of from about 105 to about 114° C.

4. The composition of claim 1, wherein the second epoxy resin is a product reaction of epichlorohydrin and bisphenol A.

5. The composition of claim 1, wherein the second epoxy resin has a softening point T(g) of from about 126 to about 137° C.

6. The composition of claim 1, wherein the third epoxy resin is a carboxyl-terminated-butadiene-nitrile (CTBN) modified epoxy resin that is an adduct of a bisphenol A epoxy resin and carboxyl-terminated-butadiene-nitrile rubber.

7. The composition of claim 1, wherein the third epoxy resin has a softening point T(g) of from about 65 to about 85° C.

8. The composition of claim 1, wherein the binder resin portion consists of the first epoxy resin, the second epoxy resin, and the third epoxy resin.

9. The composition of claim 1, wherein the binder resin portion comprises the first epoxy resin present in a first amount of from about 40 to about 50 wt. %, the second epoxy resin present in a second amount of from about 45 to about 55 wt. %, and the third epoxy resin present in a third amount of from about 1 to about 10 wt. %, based on the total weight of the binder resin portion.

10. The composition of claim 1, wherein a ratio of the first epoxy resin, the second epoxy resin, and the third epoxy resin is from about 0.9:1:0.1 to about 1:1:0.3.

11. The composition of claim 1, wherein the binder curing portion comprises a curing agent comprising dicyandiamide, pyromellitic diahydride, tetrahydrophthalic anhydride, benzophenone tetracarboxylic dianhydride, trimellitic acid, an anhydride curing agent, an aromatic amine, an aliphatic amine, ethylene diamine, diethylene triamine, triethylene tetramine, dimethylamine propylamine, benzyldimethylamine, methylene dianiline, or a combination thereof

12. The composition of claim 11, wherein the curing agent comprises dicyandiamide.

13. The composition of claim 11, wherein binder curing portion further comprises an accelerator.

14. The composition of claim 13, wherein the accelerator comprises 2-methyl imidazole.

15. The composition of claim 11, wherein the binder curing portion is present in the binder in an amount of from about 3 to about 7 wt. % based on the total weight of the binder.

16. The composition of claim 1, further comprising one or more flow control agents, pigments and/or dyes, performance enhancers, processing agents, additives, or a combination thereof.

17. The composition of claim 16, wherein binder is present in an amount of from about 70 to about 100 wt. % based on the total weight of the composition.

18. A powder coating made by;
dry mixing a composition comprising:
a binder comprising a binder resin portion and a binder curing portion, wherein the binder resin portion comprises:
a first epoxy resin having an epoxide equivalent weight of from about 400 to about 450 g/eq;
a second epoxy resin having an epoxide equivalent weight of from about 1600 to about 1950 g/eq; and
a third epoxy resin having an epoxide equivalent weight of from about 850 to about 1050 g/eq;
extruding the composition;
cooling the composition to form a solid; and
grinding the composition into a powder.

19. A method for coating an article, the method comprising the steps of:
applying a powder coating to the article to form a powder coated article, wherein the powder coating is made by:
dry mixing a composition comprising:
a binder comprising a binder resin portion and a binder curing portion, wherein the binder resin portion comprises:
a first epoxy resin having an epoxide equivalent weight of from about 400 to about 450 g/eq;
a second epoxy resin having an epoxide equivalent weight of from about 1600 to about 1950 g/eq; and
a third epoxy resin having an epoxide equivalent weight of from about 850 to about 1050 g/eq;
extruding the composition;
cooling the composition to form a solid; and
grinding the composition into a powder; and
exposing the powder coated article to heat.

20. The method of claim 19, wherein exposing the powder coated article to heat comprises curing the powder coating to form a cured powder coated article having a heat shock resistance up to at least about 220° C.
